(19) United States
(12) Patent Application Publication
(10) Pub. No.: US 2009/0162752 A1
(43) Pub. Date: Jun. 25, 2009

(54) Zinc Can of Environmental Protection Type for Battery and Manufacture Method Thereof

(75) Inventor: Qinghua Jiang, Guangzhou City (CN)

Correspondence Address: SEYFARTH SHAW LLP, 131 S. DEARBORN ST., SUITE 2400, CHICAGO, IL, 60603-5803, US

(73) Assignee: Asia Royal Development Limited, Hong Kong (CN)

(21) Appl. No.: 11/887,690

(22) PCT Filed: Apr. 25, 2006
(86) PCT No.: PCT/CN2006/000787

§ 371 Date: Dec. 8, 2008

(30) Foreign Application Priority Data
Apr. 26, 2005 (CN) 200510034372.7
Apr. 24, 2006 (CN) 200610075926.2

(51) Int. Cl. H01M 4/42; H01M 4/84

(52) U.S. Cl. 429/229; 29/623.1

(57) ABSTRACT

A zinc can of environmental protection type for battery and the manufacture method thereof, the zinc can is formed of a zinc base alloy including 0.001-0.04 wt % of aluminum, without containing non-occasional impurity such as cadmium, lead, iron and copper. A zinc base alloy liquid is formed by melting pure zinc to which aluminum is added; the zinc base alloy liquid is cast and cooled in continuous casting machine at a certain speed so as to obtain a continuous cast zinc band; the continuous cast zinc band is rolled on rolling mill so as to obtain a zinc coiled plate or zinc sheet with a predetermined thickness; the zinc coiled plate or zinc sheet is punched in hot state or cold state on a punch press such that a round or hexagonal zinc pellet is obtained; The zinc pellet is placed in a furnace with a constant temperature within a temperature range of 150-200° C. for 2-8 hours, and then is taken out for cooling naturally to the room temperature; The zinc pellet is stretched into a whole zinc can on a punch press. The zinc can does not contain any harmful substances such as lead, cadmium, mercury and so on, so that the battery exhausted poses no pollution to the environment and also maintains the manufacturing property, mechanical strength and corrosion resistance of the prior zinc can containing lead for battery.

### BACKGROUND OF THE INVENTION

The present invention relates to the technical field of environmental protection type battery, in particular relates to a zinc can without containing non-occasional harmful substances such as cadmium and lead.

Nowadays, dry battery which is safe and convenient to use with low price, is a widely used battery with great production. Generally, the cathode can is zinc can, the manufacturing method of which is as follows:
(1) forming a zinc base alloy by melting pure zinc to which cadmium and lead are added;
(2) casting and cooling the zinc base alloy liquid in continuous casting machine at a certain speed, so as to obtain a continuous cast zinc band;
(3) rolling the continuous cast zinc band on rolling mill so as to obtain a zinc coiled plate or zinc sheet with a predetermined thickness;
(4) punching the zinc coiled plate or zinc sheet in hot state or cold state on a punch press such that a round or hexagonal zinc pellet is obtained;
(5) pressing the zinc pellet into a whole zinc can on a punch press.

Accordingly, during the manufacturing process of the zinc can, good plastic workability and appropriate mechanical strength is required. Furthermore, the zinc can is not only the container of battery and also the active substance of electrode reaction, the zinc of which will consumed away while being used. During the storage, corrosion will also occur in the zinc can, which decreases the capacity and even leads to perforation when getting serious. To resolve the above problem, generally, lead is used as one of the major elements besides cadmium and zinc, and normally the zinc can includes 0.4-0.8 wt % of lead and 0.035-0.06 wt % of cadmium. The added cadmium increases the evolution potential of hydrogen at zinc electrode and decreases the self-consuming of zinc electrode, and the zinc particles are fine and uniform, which improves the unevenness of zinc surface and thus increases the tensile strength and the yield strength of zinc; while, the added lead may improve the extensibility of zinc, and works as lubricant when the metal flows in solid state due to extrusion, and also will reduce the hydrogen evolution at zinc electrode and improve the corrosion resistance.

However, the added cadmium and lead in zinc can would affect the environment greatly and endanger the health of the residents. With the raise of the consciousness of environmental protection, manufacturing the dry battery without containing cadmium and lead is highly urged. Especially in Europe and USA, the dry battery containing cadmium and lead will be prohibited from import as from 2006, accordingly the research on battery without containing lead is urgently required.

### SUMMARY OF THE INVENTION

An object of the present invention is to provide a zinc can of environmental protection type without containing non-occasional component lead, which maintains the manufacturing properties, the mechanical strength and the corrosion resistance of the known zinc can.

Another object of the present invention is to provide a method for manufacturing the zinc can of environmental protection type.

The technical solutions for achieving the above objects are as follows: a zinc can of environmental protection type for battery, wherein said can is formed of a zinc base alloy including 0.001-0.04 wt % of aluminum, without containing non-occasional impurity such as cadmium, lead, iron and copper.

The zinc base alloy may include 0.002-0.02 wt % of aluminum.

The zinc base alloy may include 0.002 wt % of aluminum.

Preferably, the zinc base alloy includes 0.001-0.003 wt % of magnesium.

The zinc base alloy may include 0.001 wt % of magnesium.

The zinc base alloy may include no more than 0.002 wt % of occasional impurity cadmium and no more than 0.002 wt % of occasional impurity lead.

The zinc base alloy may include no more than 0.003 wt % of occasional impurity iron.

The zinc base alloy may include no more than 0.001 wt % of occasional impurity copper.

Aluminum would replace the efficacy of the cadmium and the lead partially, and also improve the manufacturing properties of the zinc can. The added magnesium in small amount could improve the mechanical strength of the zinc can.

A method for manufacturing the zinc can of environmental protection type for battery comprises the following steps:
(1) forming a zinc base alloy liquid by melting pure zinc to which aluminum is added;
(2) casting and cooling the zinc base alloy liquid in continuous casting machine at a certain speed, so as to obtain a continuous cast zinc band;
(3) rolling the continuous cast zinc band on rolling mill so as to obtain a zinc coiled plate or zinc sheet with a predetermined thickness;
(4) punching the zinc coiled plate or zinc sheet in hot state or cold state on a punch press such that a round or hexagonal zinc pellet is obtained;
(5) placing the zinc pellet in a furnace with a constant temperature within a temperature range of 150-200° C. for 2-8 hours, and then taking out the zinc pellet for cooling naturally to the room temperature;
(6) pressing the zinc pellet into a whole zinc can on a punch press.

Preferably, in the above step (5), the zinc pellet is placed into the furnace with a constant temperature of 200° C. for 2 hours, and then taking out the zinc pellet for cooling naturally to the room temperature.

By the thermal treatment of the zinc pellet to relieve stress, the even entire elongation rate would be increased and thus the rate of finished products would be ensured.

With the zinc can of environmental protection type for battery without containing harmful substances such as lead, cadmium, mercury etc., according to the present invention, the waste battery would not contaminate the environment, which is in compliance with the requirement of protecting the environment, while the manufacturing properties, the mechanical strength and the corrosion resistance obtained in the known zinc can containing lead are maintained.

### BRIEF DESCRIPTION OF THE DRAWINGS

FIG. 1 is a schematic graph showing the comparison of the initial discharge between the embodiments of the present invention and the comparative samples;

FIG. 2 is a schematic graph showing the comparison of the discharge between the embodiments of the present invention and the comparative samples, after storage at 45° C. for one month;

FIG. 3 is a schematic graph showing the discharge curve of the embodiment 10 of the present invention used in R6PU battery;

FIG. 4 is a schematic graph showing the discharge curve of the embodiment 10 of the present invention used in R6PS battery;

FIG. 5 is a schematic view showing the compressive strength test of the can mouth;

FIG. 6 is a schematic view showing the compressive strength test of the can body.

### DETAILED DESCRIPTION OF THE INVENTION

### Embodiment 1

A method for manufacturing the zinc can of environmental protection type for battery comprised the following steps:
(1) forming a zinc base alloy liquid by melting a zinc material to which 0.001 wt % of aluminum and 0.001 wt % of magnesium are added, the zinc material containing 0.003 wt % of occasional impurity iron, 0.001 wt % of occasional impurity copper and balance zinc;
(2) casting and cooling the zinc base alloy liquid in continuous casting machine at a certain speed, so as to obtain a continuous cast zinc band;
(3) rolling the continuous cast zinc band on two high rolling mill so as to obtain a zinc coiled plate with a predetermined thickness;
(4) punching the zinc coiled plate in hot state on a punch press such that a round zinc pellet is obtained;
(5) placing the zinc pellet in a furnace with a constant temperature of 150° C. for 8 hours, and then taking out the zinc pellet for cooling naturally to the room temperature;
(6) pressing the zinc pellet into a whole zinc can on a punch press.

### Embodiment 2

A zinc can of environmental protection type for battery was formed of a zinc base alloy including 0.002 wt % of aluminum and 0 wt % of magnesium, and the zinc base alloy further contained 0.003 wt % of occasional impurity iron and 0.001 wt % of occasional impurity copper.

In the step (5) of the manufacturing method of the zinc can, the zinc pellet was placed in a furnace with a constant temperature of 200° C., and kept for 8 hours, and then taken out for cooling naturally to the room temperature. Meanwhile, the rest steps remained the same as described in embodiment 1.

### Embodiment 3

A zinc can of environmental protection type for battery was formed of a zinc base alloy including 0.005 wt % of aluminum and 0.001 wt % of magnesium.

In the step (5) of the manufacturing method of the zinc can, the zinc pellet was placed in a furnace with a constant temperature of 150° C., and kept for 2 hours, and then taken out for cooling naturally to the room temperature. Meanwhile, the rest steps remained the same as described in embodiment 1.

### Embodiment 4

A zinc can of environmental protection type for battery was formed of a zinc base alloy including 0.01 wt % of aluminum and 0.001 wt % of magnesium.

In the step (5) of the manufacturing method of the zinc can, the zinc pellet was placed in a furnace with a constant temperature of 200° C., and kept for 4 hours, and then taken out for cooling naturally to the room temperature. Meanwhile, the rest steps remained the same as described in embodiment 1.

### Embodiment 5

A zinc can of environmental protection type for battery was formed of a zinc base alloy including 0.02 wt % of aluminum and 0.001 wt % of magnesium, and the zinc base alloy further contained 0.003 wt % of occasional impurity iron and 0.001 wt % of occasional impurity copper.

In the step (5) of the manufacturing method of the zinc can, the zinc pellet was placed in a furnace with a constant temperature of 200° C., and kept for 2 hours, and then taken out for cooling naturally to the room temperature. Meanwhile, the rest steps remained the same as described in embodiment 1.

### Embodiment 6

A zinc can of environmental protection type for battery was formed of a zinc base alloy including 0.04 wt % of aluminum and 0.001 wt % of magnesium, and the zinc base alloy further contained 0.003 wt % of occasional impurity iron, 0.001 wt % of occasional impurity copper and occasional impurity 0.002 wt % of cadmium.

### Embodiment 7

A zinc can of environmental protection type for battery was formed of a zinc base alloy including 0.02 wt % of aluminum, and the zinc base alloy further contained 0.003 wt % of occasional impurity iron, 0.001 wt % of occasional impurity copper and occasional impurity 0.002 wt % of cadmium.

### Embodiment 8

A zinc can of environmental protection type for battery was formed of a zinc base alloy including 0.02 wt % of aluminum and 0.001 wt % of magnesium, and the zinc base alloy further contained 0.003 wt % of occasional impurity iron and 0.001 wt % of occasional impurity copper.

### Embodiment 9

A zinc can of environmental protection type for battery was formed of a zinc base alloy including 0.02 wt % of aluminum and 0.002 wt % of magnesium, and the zinc base alloy further contained 0.003 wt % of occasional impurity iron and 0.001 wt % of occasional impurity copper.

### Embodiment 10

A zinc can of environmental protection type for battery was formed of a zinc base alloy including 0.02 wt % of aluminum and 0.003 wt % of magnesium.

The advantages of the present invention became clear by the following tests:

Comparative sample 1: a known cathode can containing lead, the cathode can being formed of a zinc base alloy including 0.4 wt % of lead and 0.0015 wt % of magnesium, and the zinc base alloy further containing 0.003 wt % of occasional impurity iron, 0.001 wt % of occasional impurity copper and 0.002 wt % of cadmium.

Comparative sample 2: a known cathode can containing lead, the cathode can being formed of a zinc base alloy including 0.2 wt % of lead and 0.0015 wt % of magnesium, the zinc base further contains 0.003 wt % of occasional impurity iron, 0.001 wt % of occasional impurity copper and 0.002 wt % of cadmium.

Comparative sample 3: a zinc can for battery being formed of a zinc base alloy including 0.06 wt % of aluminum and 0.001 wt % of magnesium, without containing non-occasional impurity.

Comparative sample 4: a zinc can for battery being formed of a zinc base alloy including 0.1 wt % of aluminum and 0.001 wt % of magnesium, without containing non-occasional impurity.

Comparative sample 5: a zinc can for battery being formed of a zinc base alloy including 0.003 wt % of magnesium, without containing non-occasional impurity.

Comparative sample 6: a zinc can for battery being formed of a zinc base alloy including 0 wt % of aluminum and 0.001 wt % of magnesium, without containing non-occasional impurity.

Comparative sample 7: a zinc can for battery being formed of a zinc base alloy including 0.02 wt % of aluminum and 0.005 wt % of magnesium, without containing non-occasional impurity.

1. Evaluation of Rollability of Zinc Alloy

The zinc alloy liquid of the embodiments of the present invention and the zinc alloy liquid of the comparative samples were conveyed respectively into a continuous casting machine for casting and cooling at the same speed so as to obtain continuous cast zinc bands; the continuous zinc bands were rolled through a rolling mill to obtain zinc sheets with a predetermined thickness. The surfaces of the zinc sheets obtained were observed so as to evaluate effect of rolling on the appearance, and the results are shown at column “evaluation of rollability of zinc alloy” in table 2, in which “√√”, “√”, “x” and “xx” represent 4 levels of the appearance, with “√√” representing normal and “xx” representing unacceptable.

2. Punching Test of Zinc Pellet Obtained After Temper

The zinc sheets of aforesaid embodiments and the comparative samples were punched on a punch press in hot or cold state, so as to obtain round or hexagonal zinc pellets; the zinc pellets of embodiment 6 and embodiment 10 were placed in a furnace with a temperature of 150-200° C. for 2-8 hours, and taken out for cooling naturally to the room temperature. The above zinc pellets were extruded into zinc cans with a predetermined size. A certain ratio of zinc can samples were taken to inspect if any crack or flaw appeared on the can mouth or can body, so as to evaluate the characteristic of the punched zinc can. The results of evaluation are shown in table 1.

TABLE 1
Punching Test of Zinc Pellet Obtained After Temper

| | Element content in zinc | | | | | Slight Defect | |
|---|---|---|---|---|---|---|---|
| | alloy (ppm) | | | Temper | Temper | Rate | Defect Rate |
| Sample No. | Pb | Mg | Al | Temperature | Time | % | % |
| Comparative | 4000 | 15 | 0 | / | / | 0.02 | 0.00 |
| Sample 1 | | | | | | | |
| Embodiment 6 | 0 | 10 | 400 | / | / | 0.86 | 0.02 |
| Embodiment 6 | 0 | 10 | 400 | 150□ | 2 h | 0.53 | 0.01 |
| | | | | | 8 h | 0.14 | 0.00 |
| | | | | 200□ | 2 h | 0.24 | 0.00 |
| | | | | | 4 h | 0.00 | 0.00 |
| Embodiment 10 | 0 | 30 | 200 | / | / | 1.05 | 0.03 |
| Embodiment 10 | 0 | 30 | 200 | 150□ | 2 h | 1.00 | 0.01 |
| | | | | | 8 h | 0.93 | 0.00 |
| | | | | 200□ | 2 h | 0.57 | 0.00 |
| | | | | | 4 h | 0.52 | 0.00 |

Wherein:

Detect rate represents the percentage of the can having flaws which still has slight flaws after machining, that is, the final product is unqualified.

Slight defect rate represents the percentage of the can having slight flaws which does not have flaws after cutting, that is, the final product is qualified.

It is observed from the above test results that the defect rate of appearance of the punched zinc can being formed of the zinc pellet after temper decreases obviously. The results of tempering at 200° C. for 4 hours in different conditions may be arranged in the following order from higher quality to the lower: at 200° C. for 4 hours>at 200° C. for 2 hours>at 150° C. for 8hours>at 150° C. for 2 hours. Considering the operability of the practical production, preferably, the other embodiments and the comparative samples are proceed with the temper condition of 200° C. for 2 hours so as to obtain zinc cans.

3. The Defect Rate of Appearance of the Punched Zinc Can

The zinc pellets of aforesaid embodiments and the comparative samples were punched on a punch press after thermal treatment so as to be extruded into entire zinc cans. A certain ratio of zinc can samples were taken to inspect if any crack or flaw appears on the can mouth or can body, so as to evaluate the characteristic of the punched zinc can. The results of evaluation are shown in table 2.

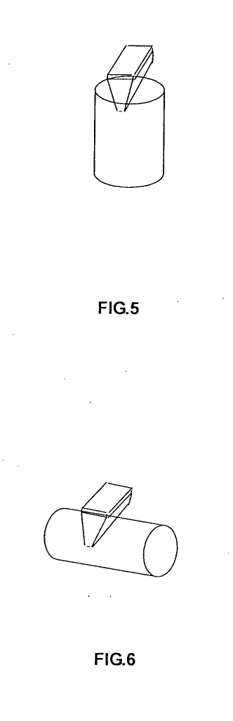

4. Comparison of Mechanical Strength Produced According to the Above Methods
(1) Compressive Strength Test of the Can Mouth
Referring to FIG. 5, the zinc can sample is placed upright on a horizontal metal platform and pressed downwards until the zinc can mouth is collapsed by using a V-shaped metal die lying along the diameter direction of the zinc can mouth. The pressure added is recorded when the zinc can mouth is collapsed.
(2) Compressive Strength Test of the Can Body
Referring to FIG. 6, the zinc can sample is placed transversally on a V-shaped trough and with a V-shaped metal die lying on the zinc can body. The zinc can body is pressed with a constant pressure of 100 N at a distance of 20 mm from the zinc can mouth, and deformed accordingly. When such deformation becomes steady, the difference between the outer diameters at the force bearing point before test and after test is measured. The test results are shown in table 2.

5. Evaluation of Corrosion Resistance of the Zinc Can

The zinc cans were submerged in electrolyte for reaction, so as to calculate the reduction of the zinc cans due to corrosion. The details of test are as follows:
\textcircled{1} The bodies of the cathode zinc cans were washed by 10% NaOH solution, and then cleaned by distilled water, and finally aired for use;
\textcircled{2} An electrolyte was prepared by diluting the 46% ZnCl₂ solution with pure water at the ratio of 55:45;
\textcircled{3} The cleaned zinc cans having been weighed were disposed into bottles with the electrolyte in a constant temperature box with a temperature of 45° C. for three days, whereafter the zinc cans were taken out for cleaning and airing to obtain weights, so that the reductions of the zinc cans were calculated accordingly.
\textcircled{4} The reduction data of the zinc cans are shown in table 2.

TABLE 2
Table of the Performance of the Zinc Cans Made of Different Zinc Alloy

| | | | | | | | Mechanical Strength of | | |
|---|---|---|---|---|---|---|---|---|---|
| | | | | | | | Zinc Can | | |
| | | | | | | | Pressure | Deformation | |
| | | | | Evaluation | Defect Rate of | | borne by the | of Zinc Body | |
| | Added Element in | | | of | Appearance of the | | can mouth | under the | Reduction |
| | Zinc Alloy and Its | | | Rollability | Punched Can (%) | | when | Pressure | due to |
| | Content (ppm) | | | of Zinc | Slight | | collapsing | of 100 N | Corrosion |
| Sample No. | Pb | Mg | Al | Alloy | Defect | Defect | (N) | (mm) | (wt %) |
| Comparative | 4000 | 15 | 0 | ✓✓ | 0.01 | 0 | 440 | 1.83 | 0.23 |
| Sample 1 | | | | | | | | | |
| Comparative | 2000 | 15 | 0 | ✓✓ | 0.01 | 0 | 418 | 1.93 | 0.25 |
| Sample 2 | | | | | | | | | |
| Comparative | 0 | 10 | 600 | ✓ | 0.38 | 0 | 427 | 1.89 | 0.76 |
| Sample 3 | | | | | | | | | |
| Comparative | 0 | 10 | 1000 | ✓ | 0.41 | 0.04 | 420 | 1.97 | 0.84 |
| Sample 4 | | | | | | | | | |
| Comparative | 0 | 30 | 0 | ✓✓ | 0.90 | 0.05 | 370 | 2.03 | 0.35 |
| Sample 5 | | | | | | | | | |
| Comparative | 0 | 10 | 0 | ✓✓ | 0.18 | 0 | 354 | 2.66 | 0.38 |
| Sample 6 | | | | | | | | | |
| Comparative | 0 | 50 | 200 | ✓ | 0.78 | 0.08 | 470 | 1.73 | 0.74 |
| Sample 7 | | | | | | | | | |
| Embodiment 1 | 0 | 10 | 10 | ✓✓ | 0.34 | 0 | 366 | 2.42 | 0.45 |
| Embodiment 2 | 0 | 0 | 20 | ✓✓ | 0.30 | 0 | 350 | 2.75 | 0.42 |
| Embodiment 3 | 0 | 10 | 50 | ✓✓ | 0.32 | 0 | 404 | 2.02 | 0.50 |
| Embodiment 4 | 0 | 10 | 100 | ✓✓ | 0.10 | 0 | 414 | 1.97 | 0.43 |
| Embodiment 5 | 0 | 10 | 200 | ✓✓ | 0.10 | 0 | 412 | 1.93 | 0.45 |
| Embodiment 6 | 0 | 10 | 400 | ✓✓ | 0.46 | 0 | 428 | 1.95 | 0.50 |
| Embodiment 7 | 0 | 0 | 200 | ✓✓ | 0.59 | 0 | 291 | 3.69 | 0.41 |
| Embodiment 8 | 0 | 10 | 200 | ✓✓ | 0.10 | 0 | 412 | 1.93 | 0.45 |
| Embodiment 9 | 0 | 20 | 200 | ✓✓ | 0.16 | 0 | 396 | 1.99 | 0.42 |
| Embodiment 10 | 0 | 30 | 200 | ✓✓ | 0.57 | 0 | 390 | 1.96 | 0.38 |

As shown in table 2:
1) Comparing with the embodiments 1-10, the comparative samples 3, 4, containing about 0.001 wt % of magnesium and about 0.06-0.1 wt % of aluminum and with sufficiently the same mechanical strength increase in reduction due to corrosion, so that the increase in content of aluminum goes against the corrosion resistance.
2) Comparing with the embodiments 1-10, the comparative samples 5, 6 without containing aluminum are of relative high defect rate. The mechanical strength of comparative sample 6 is worse than that of the comparative sample 5. The mechanical strength would be improved by appropriate increase in magnesium content.
3) In the embodiments 1-10, the zinc alloy containing 0.001-0.04 wt % of aluminum and 0.001-0.003 wt % of magnesium is of better performance in the can formation and the corrosion resistance.

In the comparative sample 7, the magnesium content is increased to 0.005 wt %, and the flaw defect rate of the first made can increases, which leads to decrease in sealing property of the final battery.

6. Batteries Made by Using the Embodiments

Taking the battery of R6PS type as an example, the batteries with the zinc cans of the above embodiments and comparative samples were made by adding isolated layer and paste of zinc chloride type. The batteries obtained were evaluated by test, and the test results are shown in table 3.

Wherein:

Test of incorrect assembly: 4 batteries with the same grade are connected in series, and one of them is in opposite direction. The circuit is kept connected until the surface temperature of battery returns to the environmental temperature, and the battery shall not explode.

Short-circuit test: connect the positive electrode and the negative electrode of a battery directly until the surface temperature of battery returns to the environmental temperature, and the battery shall not explode.

Temperature cycle test: 20° C.→70□ for 4 h→20□ for 2 h→−20□ for 4 h→20□, repeat 10 cycle and then store for 7 days (see IEC60086-5 6.2.2.4).

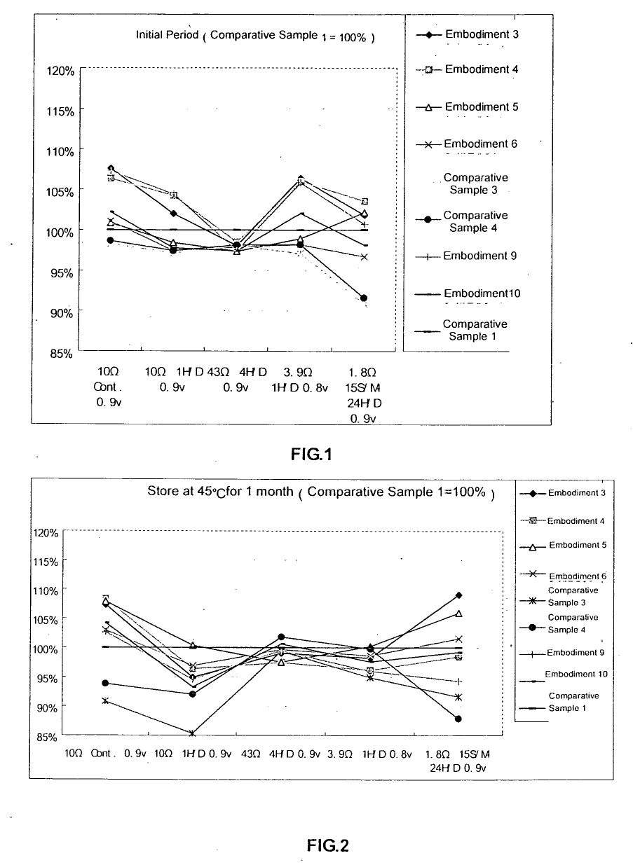

In order to compare the performance of the embodiments with that of the comparative samples more clearly, the embodiments 3, 4, 5, 6, 9, 10 having better performance of zinc can and corrosion resistance were chosen for compare with comparative sample 1, 3, 4, according to the test condition of IEC60086/GB8897, as shown in FIG. 1 and FIG. 2. In FIG. 1 and FIG. 2, the comparative sample 3 and the comparative sample 4 perform a little worse than the comparative sample 1 in discharge performance, especially after store at a temperature of 450, and the embodiments 3, 4, 5, 6, 9, 10 have equivalent discharge performance with the comparative sample 1 and obviously are higher than the standard requirement in IEC60086/GB8897.

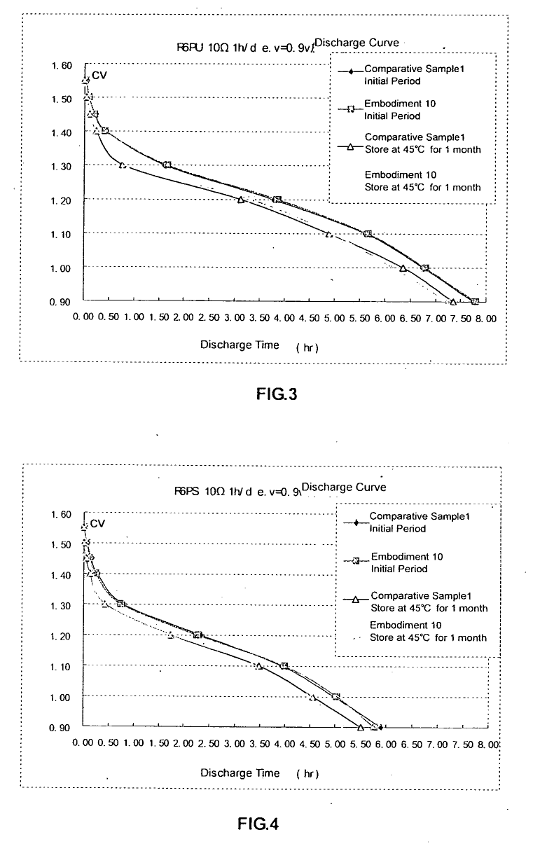

In order to further obtain the performance of the batteries, preferably the embodiment 10 was selected for preparing batteries with different grade by using different anode prescription. The batteries performed the discharge test, and the discharge curves were drawn to compare with that of the comparative sample 1, as shown in FIG. 3 and FIG. 4. It is observed that the discharge performance of the embodiment 10 is equivalent to that of the comparative sample 1.

TABLE 3
Test Results of Batteries with Different Zinc Cans (R6PS Type)
Items

| | Test Results | | | | | | | | | |
|---|---|---|---|---|---|---|---|---|---|---|
| | | | | | | | | Leakage Preventing Performance | | |
| | | | | | | | | During Initial Period | | |
| | | | | | | | | IEC/ | | |
| | | | | | Safety Performance | | | GB8897 | | |
| | Discharge Performance (h) | | | | During | | | Under | | |
| | Initial Period | | Store at 45□ | | Initial Period | | | standard | Enhanced Test | |
| | 0M | | One | | | | Temper- | store | With | With |
| | 10Ω 1 hr/ | 43Ω 4 hr/ | 10Ω 1 hr/ | 43Ω 4 hr/ | Test of | Short- | ature | condition, | 3.9Ω, | 5Ω, |
| | 24 hr | 24 hr | 24 hr | 24 hr | incorrect | circuit | cycle | discharge | discharge | discharge |
| Sample No. | E.V = 0.9 V | E.V = 0.9 V | E.V = 0.9 V | E.V = 0.9 V | assembly | test | test | to 0.6 V | to 0.35 V | for 24 hr |

| | | | | | | | | | | |
|---|---|---|---|---|---|---|---|---|---|---|
| IEC/GB8897 | ≧4.1 h | ≧27 h | / | / | unex- | unex- | unex- | No | / | / |
| | | | | | ploded | ploded | ploded | leakage | | |
| Comparative | 5.90 | 30.80 | 5.51 | 28.81 | qualified | qualified | qualified | qualified | No | No |
| Sample 1 | | | | | | | | | leakage | leakage |
| Comparative | 5.84 | 29.69 | 5.33 | 28.03 | qualified | qualified | qualified | qualified | No | No |
| Sample 2 | | | | | | | | | leakage | leakage |
| Comparative | 5.73 | 30.21 | 4.70 | 28.64 | qualified | qualified | qualified | qualified | No | No |
| Sample 3 | | | | | | | | | leakage | leakage |
| Comparative | 5.75 | 30.23 | 5.27 | 29.34 | qualified | qualified | qualified | qualified | No | No |
| Sample 4 | | | | | | | | | leakage | leakage |
| Comparative | 5.68 | 29.45 | 5.29 | 27.96 | qualified | qualified | qualified | qualified | No | No |
| Sample 5 | | | | | | | | | leakage | leakage |
| Comparative | 5.15 | 28.37 | 4.96 | 27.53 | qualified | qualified | qualified | qualified | No | 1/10 |
| Sample 6 | | | | | | | | | leakage | leakage |
| Comparative | 6.16 | 30.31 | 5.79 | 29.56 | qualified | qualified | qualified | qualified | No | No |
| Sample 7 | | | | | | | | | leakage | leakage |
| Embodiment 1 | 5.23 | 29.02 | 5.05 | 27.96 | qualified | qualified | qualified | qualified | No | No |
| | | | | | | | | | leakage | leakage |
| Embodiment 2 | 5.56 | 27.96 | 4.97 | 26.55 | qualified | qualified | qualified | qualified | No | No |
| | | | | | | | | | leakage | leakage |
| Embodiment 3 | 5.48 | 27.89 | 4.87 | 26.99 | qualified | qualified | qualified | qualified | No | No |
| | | | | | | | | | leakage | leakage |
| Embodiment 4 | 6.15 | 30.34 | 5.68 | 28.97 | qualified | qualified | qualified | qualified | No | No |
| | | | | | | | | | leakage | leakage |
| Embodiment 5 | 5.81 | 29.99 | 5.53 | 28.10 | qualified | qualified | qualified | qualified | No | No |
| | | | | | | | | | leakage | leakage |
| Embodiment 6 | 5.75 | 30.15 | 5.34 | 28.71 | qualified | qualified | qualified | qualified | No | No |
| | | | | | | | | | leakage | leakage |
| Embodiment 7 | 5.66 | 29.74 | 5.49 | 28.35 | qualified | qualified | qualified | qualified | No | No |
| | | | | | | | | | leakage | leakage |
| Embodiment 8 | 5.81 | 29.99 | 5.53 | 28.10 | qualified | qualified | qualified | qualified | No | No |
| | | | | | | | | | leakage | leakage |
| Embodiment 9 | 6.16 | 30.02 | 5.88 | 29.23 | qualified | qualified | qualified | qualified | No | No |
| | | | | | | | | | leakage | leakage |
| Embodiment 10 | 5.77 | 30.01 | 5.14 | 29.00 | qualified | qualified | qualified | qualified | No | No |
| | | | | | | | | | leakage | leakage |

As shown in table 3, the safety performance and the leakage preventing performance of all the embodiments meet the requirements of IEC60086/GB8897, and are better than the standard requirement. The discharge performance during the initial period satisfies the above standard. In order to further evaluate the performance of batteries, the discharge test after store at 45° C. for 1 month is performed, and the test results are favorable. According to table 3, all the batteries made of the zinc cans of the embodiments are of qualified discharge performance, safety performance and leakage preventing performance.

As indicated by the above tests, when the zinc alloy includes 0.001 wt %-0.003 wt % of magnesium and 0.001 wt %-0.04 wt % of aluminum, without containing lead, mercury and cadmium, the battery with the cathode zinc can obtained thereby satisfies the requirements of IEC60086/GB8897.

We claim:

1. A zinc can of environmental protection type for battery, wherein said can is formed of a zinc base alloy including 0.001-0.04 wt % of aluminum, without containing non-occasional impurity such as cadmium, lead, iron or copper.

2. The zinc can of environmental protection type for battery of claim 1, wherein said zinc base alloy includes 0.002-0.02 wt % of aluminum.

3. The zinc can of environmental protection type for battery of claim 1, wherein said zinc base alloy includes 0.002 wt % of aluminum.

4. The zinc can of environmental protection type for battery of claim 1 or 2 or 3, wherein said zinc base alloy includes 0.001-0.003 wt % of magnesium.

5. The zinc can of environmental protection type for battery of claim 4, wherein said zinc base alloy includes 0.001 wt % of magnesium.

6. The zinc can of environmental protection type for battery of claim 4, wherein said zinc base alloy includes no more than 0.002 wt % of occasional impurity cadmium and no more than 0.002 wt % of occasional impurity lead.

7. The zinc can of environmental protection type for battery of claim 4, wherein said zinc base alloy includes no more than 0.003 wt % of occasional impurity iron.

8. The zinc can of environmental protection type for battery of claim 4, wherein said zinc base alloy includes no more than 0.001 wt % of occasional impurity copper.

9. A method for manufacturing the zinc can of environmental protection type for battery of claim 1, said method comprising:
(1) forming a zinc base alloy liquid by melting pure zinc to which aluminum is added;
(2) casting and cooling the zinc base alloy liquid in continuous casting machine at a certain speed, so as to obtain a continuous cast zinc band;
(3) rolling the continuous cast zinc band on rolling mill so as to obtain a zinc coiled plate or zinc sheet with a predetermined thickness;
(4) punching the zinc coiled plate or zinc sheet in hot state or cold state on a punch press such that a round or hexagonal zinc pellet is obtained;
(5) placing the zinc pellet in a furnace with a constant temperature within a range of 150-200° C. for 2-8 hours; and then taking out the zinc pellet for cooling naturally to the room temperature;
(6) pressing the zinc pellet into a whole zinc can on a punch press.

10. The method of claim 9, wherein in said step (5), the zinc pellet is placed into the furnace with a constant temperature of 200° C. for 4 hours, and then taking out the zinc pellet for cooling naturally to the room temperature.
